(19) United States
(12) Patent Application Publication
(10) Pub. No.: US 2005/0031768 A1
(43) Pub. Date: Feb. 10, 2005

(54) Fractionation of allyl isothiocyanate, p-hydroxybenzyl-isothiocyanate, protein and fiber from mustard

(76) Inventors: Shiro Sakai, Saitama-shi (JP); Makoto Sakai, Saitama-shi (JP); Hisao Tanaka, Saitama-shi (JP); Toshio Kon, Saitama-ken (JP); Kenji Tsukazaki, Sakado-shi (JP)

Correspondence Address: CASTELLANO MALM FERRARIO & BUCK LLC, 2121 K STREET, NW, SUITE 800, WASHINGTON, DC, 20037, US

(21) Appl. No.: 10/895,318

(22) Filed: Jul. 21, 2004

(30) Foreign Application Priority Data
Aug. 7, 2003 (CA) 2,436,711

(51) Int. Cl. C11B 1/00

(52) U.S. Cl. 426/629

(57) ABSTRACT

Yellow or oriental mustard seed can be fractionated to produce allyl isothiocyanate and p-hydroxybenzyl isothiocyanate, along with prepared mustard products, mustard protein and dietary fiber. Processes for the production of these various fractions from mustard seed stock are disclosed. The seed stock is comminuted with water to yield an activated slurry in which the enzyme myrosinase hydrolyses and deteriorates glycosinolates in the seed stock to isothiocyanates. Remaining slurry can then be sterilized and further conventionally processed to yield improved finished mustard products.

This application is in the field of food processing. More particularly, it is in the field of processing plant matter, namely mustard seed, into various useful and/or improved fractions.

### BACKGROUND OF THE INVENTION

People have used mustard for many years both for its flavoring qualities and medicinal properties. In producing a mustard product, the ultimate goal is to maximize the pungency, taste and medicating effects and to maintain the presence of other desired components in the final product. When mustard is used as a flavoring or spice, the main problems in this technical field are preserving maximum flavor, as well as extending the shelf life of the mustard product. The generation of heat during processing, the presence of mustard seed oils and moisture, as well as the activity of the mustard enzymes such as myrosinase are all determining factors in the quality of the final mustard product.

Different types of mustard seed yield differing products with respect to flavor and pungency. The pungency of mustard is dependent on the enzymatic breakdown of particular mustard seed glycosides, chemically known as glycosinolates, into various isothiocyanate compounds, collectively referred to as mustard oils, by the enzyme myrosinase. In yellow mustard seed, the key glycoside in terms of flavor and pungency production is known as sinalbin. Sinalbin is enzymatically degraded by myrosinase to produce D-glucose and p-hydroxybenzyl isothiocyanate (benzyl oil). Benzyl oil is a non-volatile compound and is the primary flavor component of this seed stock. In Oriental mustard, the key glycoside in terms of flavor and pungency is sinigrin. Sinigrin is also degraded by myrosinase, but the products formed from the hydrolysis of sinigrin are D-glucose and allyl isothiocyanate (allyl oil). It is allyl oil that gives oriental mustard its characteristic heat and pungency, both highly desirable properties of this type of mustard.

For all mustard varieties, the enzyme myrosinase is critical to the development of mustard flavor in the finished mustard product. However, temperatures above 45° C. inactivate the myrosinase enzyme. Therefore, any method of production that involves heating the mixture to temperatures above 45° C. will make impossible to maintain the activity of myrosinase, with the result that mustard oil production (either allyl oil or benzyl oil depending on the mustard seed stock used), and the resulting flavor properties will be similarly impaired.

Because of the labile nature of myrosinase, handling of the mustard seed before and during processing can affect the properties of the final mustard product. For example, in U.S. Pat. No. 4,496,598, to Sakai for the preparation of mustard flour, the mustard seed is subjected to high heat prior to grinding in order to deliberately inactive myrosinase, resulting in a milder mustard product. However, where a more pungent mustard product is desired, the process disclosed in the '598 patent would not be appropriate. Canadian Patent Ser. No. 2,250,020 to Sakai et al. discloses a method of production of mustard powder in which the activity of myrosinase and the quality and quantity of mustard oils (either benzyl or ally oils) are maximized. Additionally, other key issues in the manufacture of prepared mustard, not resolved in the prior art methods and processes, are extending the shelf life of the product and stabilizing the flavor in the product, such that the mustard products will have the desired flavor characteristics when used.

In the past, prepared mustard has been manufactured by a process of crushing mustard seed or mustard cake; expelling crude oil from the crushed seed; then soaking the mustard powder in a seasoned liquid to allow flavor and pungency to develop. Soaking in liquid, typically water, activates myrosinase enzyme activity while at the same time controlling the evaporation or destruction of volatile flavor-yielding or otherwise beneficial compounds. The resulting product is subsequently modified with the addition of others spices or ingredients as desired to adjust the flavor.

Unfortunately, current methods of production do not adequately solve the problems of shelf life limitations or flavor stability. Flavor and pungency diminish over time, as the desired mustard oils benzyl oil and allyl oil are either lost by evaporation or by chemical conversion into other compounds. In addition, the mustard product becomes susceptible to bacterial contamination, which leads to spoilage. Typically, salt or vinegar is added to prepared mustard products to maintain flavor and improve shelf life by controlling myrosinase activity and inhibiting bacterial growth. The effectiveness of traditional additives is limited however, and so the shelf life of products produced by prior art methods is still very short.

The allyl isothiocyanate (also known as allyl oil) is a volatile compound which is the desired product of oriental mustard, with known uses in the food and chemical industries outside of its value as a component of mustard products. Not only is allyl oil responsible for the pungency of oriental mustard, but it has also been shown to possess anti-microbial properties as well. Currently, pure allyl oil is produced by synthetic means which require expensive chemical manufacturing equipment and the handling of potentially damaging precursor compounds. Thus, any process that would successfully yield high-grade allyl oil from a source such as mustard seed or other natural sources into other products would be desirable.

### SUMMARY OF THE INVENTION

The object of the present invention is to provide an improved method of processing mustard seed or mustard cake to yield prepared mustard and other mustard fractions or products.

It is the further object of the present invention to provide a mustard processing method, which can be used to extract or produce allyl isothiocyanate (allyl oil) from mustard seed in the course of processing mustard seed into other fractions or products. In this regard, it is a further object of the invention to extract relatively pure allyl oil with a long shelf life, by removing any residual enzymes, compounds or other matter, which could degrade the allyl isothiocyanate, or affects its quality, during periods of prolonged storage.

It is the further object of the present invention to provide a process which would yield the production of p-hydroxybenzyl isothiocyanate (benzyl oil) from appropriate mustard seed stock, again either for the purpose of removal of the benzyl oil from the mustard product in question or alternatively for the removal of the benzyl oil for its subsequent separate purification and use.

It is the further object of the present invention to produce purified fractions of mustard protein and dietary fiber, which have uses in the production of processed meats, health food, feed and fertilizer.

Therefore, using the process of the present invention, mustard seed can be fractionated into the following useful and stable products: prepared mustard, allyl oil, mustard protein and dietary fiber.

The invention, a method of fractionating mustard seed yielding allyl oil, comprised of the steps of cracking mustard seed stock to be processed, wherein that mustard seed stock contains the glucosoinolate sinigrin and the enzyme myrosinase. Once the mustard seed stock has been cracked it is combined with water, which yields an activated mustard slurry, since the water activates the enzyme myrosinase contained therein. The myrosinase-dependant hydrolysis is then allowed to take place in the activated mustard slurry and the hydrolysis converts the sinigrin into the fractioned allyl isothiocyanate (allyl oil). The myrosinase-dependant hydrolysis is conducted for a period of time, being a contact period, at a predetermined temperature and predetermined atmospheric pressure. Finally, the allyl oil, which is yielded from the hydrolysis step, is separated from the remainder of the activated mustard slurry. The remainder of the activated mustard slurry, following removal of the allyl oil, is now spent mustard slurry.

In this new process, allyl oil is distilled off from the remainder of the mustard slurry from the beginning of the myrosinase-dependant hydrolysis stage, under conditions of reduced pressure and controlled temperature, preferably at a pressure of 45 mM Hg and a temperature of 45° C.±5° C. By using available types of heat exchanging equipment such as a scraping-type heat-exchanging unit commonly used in the food preparation industry, enzyme activity in the slurry can be carefully controlled during the hydrolysis stage. Distillation yields pure allyl oil substantially free of other mustard slurry components. Once the hydrolysis and distillation processes are complete, the remainder of the slurry can be heated for the purpose of disinfection, preferably to 85° C.±10° C. in a scraping-type heat-exchanging unit. This inactivation of the remaining enzyme activity and microbes by the disinfection step is a key to producing a prepared mustard slurry that has the properties of a long shelf life and chemical stability. This disinfected mustard product can be reconstituted to a desired flavor and pungency by the subsequent addition of a quantity of the purified allyl oil.

The mustard seed stock can be obtained by crushing, grinding or other cracking methods.

It is presently contemplated that the ratio of cracked mustard seed stock and water in the activated mustard slurry in this case would be in the range of 1:1 to 1:7 by weight.

The disinfected mustard slurry, which is yielded by incubation of the spent mustard slurry, is a prepared mustard product in which the enzyme activity of myrosinase has been removed due to the incubation.

The disinfected mustard slurry or prepared mustard product could also be dewatered.

In addition to using virgin mustard seed stock to prepare the cracked mustard seed stock with the process of the present invention, cracked mustard seed stock could also be mustard cake that was previously produced by the crushing of mustard seed containing the requisite compounds.

Another mustard fraction or product that has utility is mustard protein. It is contemplated that a mustard protein fraction could be produced in accordance with the present invention using batches of mustard seed stock that were not of sufficient quality for use in higher value mustard flavorings or products. Mustard protein can be used to enrich or enhance the flavor and properties of prepared meats or fish.

The present invention could also be used in the production of a dietary fiber fraction from mustard stock. Once the mustard protein is separated from the stock, the remainder of the seed material could be dried by conventional methods, and used as a dietary fiber supplement for use in health foods, feed or fertilizer.

### DETAILED DESCRIPTION OF THE PREFERRED EMBODIMENTS

Prepared mustard of a superior flavor profile and stability, and possessing a longer shelf life, is produced by the method of the present invention. Purified stable fractions of mustard, namely allyl oil, mustard protein and dietary fiber are also produced by the method of the present invention.

Production of Prepared Mustard:

The process of the present invention can be used to make prepared mustard and other mustard fractions using either primarily oriental mustard seed, or alternatively yellow mustard seed as the base of the primary mustard stock.

The first step in the process of the present invention is to obtain or prepare the mustard seed stock to be used in the process. The mustard seed stock is cracked, either by grinding or crushing or pressing or other activities. Alternatively, a mustard cake material produced by the prior crushing of mustard seed could also be used and that cake could be broken up or blended with any other raw mustard seed material to create the initial starting batch of mustard seed stock to be used in the process. Once the mustard seed stock has been cracked, the process can be continued.

Regardless of the starting material, the next stage in the process involves placing the cracked mustard seed stock along with water in a reaction chamber in which hydrolysis and distillation can occur under conditions of reduced pressure. Combining the cracked mustard seed stock with water to activate the enzyme myrosinase contained therein effectively creates an activated mustard slurry. The myrosinase hydrolysis will take place in a reaction chamber or the like in the activated mustard slurry and, on this basis, the hydrolysis will convert or degrade sinigrin in the activated mustard slurry into the fractioned allyl isothiocyanate. This is also known as allyl oil. The hydrolysis will be conducted over a period of time that is appropriate to create the requisite or desired amount of allyl oil, at a predetermined effective temperature and at a predetermined effective atmospheric pressure.

It is contemplated that the ratio of cracked mustard seed stock to water in the activated mustard slurry is in the range of 1:1 to 1:7 by weight.

In terms of temperature of pressure, it is contemplated that the hydrolysis would likely take place in the range of 30 to 90 minutes in a preferable temperature range of 40° C. to 50° C. and at a pressure of 45 mM Hg. Under these conditions, hydrolysis of the sinigrin present in this type of mustard seed stock would produce volatile allyl oil, which is simultaneously distilled off of the reaction chamber and the activated mustard slurry. The removal of allyl oil from the activated mustard slurry by distillation will significantly improve the self-life of the prepared mustard products yielded from the remainder or spent mustard slurry, as the normal breakdown of allyl oil contributes significantly to product spoilage.

Thus, the process yields a spent mustard slurry in which hydrolysis has taken place and from which allyl oil is generated by myrosinase activity. The allyl oil is evaporated by conditions of increased temperature and decreased pressure and is distilled away from the remainder or remaining spent mustard slurry.

The allyl oil can then be further processed or purified for other purposes.

Where primarily yellow mustard seed is used rather than oriental mustard seed, the same preparation of the mustard seed stock or mustard cake material will be undertaken. The mustard seed used will be crushed or cracked and will be combined with a crushed mustard cake material or the like. The cracked mustard seed stock will then be, again, potentially combined in a reaction chamber with lukewarm water, again at a ratio in the range of 1:2 to 1;7 parts of mustard seed stock to water by weight. Again, hydrolysis would be allowed to take place for a period of time during which, in the case of yellow mustard seed in which the glucosinolate sinalbin is present rather than the glucosinolate sinigrin, which is present in oriental mustard seed. The cracked mustard seed stock in question would be combined with water to activate the enzyme myrosinase therein and create an activated mustard slurry. The myrosinase induced hydrolysis taking place in that activated mustard slurry would convert the sinalbin into the fraction p-hydroxybenzyl isothiocyanate (benzyl oil) and the hydrolysis could be conducted for a period of time which is a contact period at a predetermined effective temperature.

Once the appropriate or desired amount of benzyl oil has been created or, alternatively, once the appropriate desired amount of the glucosoinolate sinalbin has been degraded or removed from the cracked mustard seed stock in this process, the activated mustard slurry can be disinfected by heating. The temperature of the activated mustard slurry is raised to the range of 85° C.±10° C. to inactivate any myrosinase enzyme activity and to disinfect the activated mustard slurry. Raising the temperature in this fashion will also serve to degrade the benzyl oil that was produced from the degradation of the sinalbin. Since benzyl oil is not volatile, it is not distilled from the activated mustard slurry as is done with the allyl oil. Degradation of the benzyl oil during the disinfection or incubation step significantly improves the self-life of the mustard products in question, since the other breakdown products of benzyl oil contribute to mustard spoilage.

Thus, at this stage in the process, where oriental mustard seed is concerned, any remaining allyl oil has been removed by distillation and any enzymes which might have otherwise contributed to spoilage of finished prepared mustard products have been inactivated. Similarly, in the case of yellow mustard containing the glucosoinolate sinalbin resulting in the presence of benzyl oil rather than allyl oil in the activated mustard slurry following hydrolysis, the benzyl oil would be degraded by the incubation step and the sinalbin would have been expended or removed during the hydrolysis stage. Similarly, again, myrosinase or enzymes, which might otherwise contribute to the spoilage of finished products, have also been inactivated at that time.

Following disinfection or other heating, the temperature of the disinfected mustard slurry of either yellow or oriental mustard can be lowered to room temperature or whatever other temperature might be required for any subsequent processing steps. The disinfected mustard slurry yielded in either case is prepared mustard.

At this point, the prepared mustard product could again be heated for further disinfection, preferably to a temperature of 80° C.±5° C. for the desired length of time. After this further disinfection, the temperature can then be lowered to room temperature or whatever temperature is required for any subsequent processing steps.

Production and Purification of Allyl Isothiocyanate (Allyl Oil):

The process of the present invention also provides for the extraction or production of pure allyl isothiocyanate (allyl oil) during the processing of prepared mustard. The allyl oil can be distilled simultaneously with its production from the glucosinolate sinigrin, present in oriental mustard seed, by the hydrolysis action of the enzyme myrosinase. As described further herein, the cracked mustard seed stock in question is mixed with water to produce an activated mustard slurry. Under conditions of controlled temperature and reduced pressure, volatile allyl oil will be distilled back through the mustard slurry. As the allyl oil might in many cases be distilled along with water, the present invention also contemplates additional steps for the purification of the allyl oil. This might be accomplished by techniques such as redistillation, or separation by sedimentation (allyl oil has a specific gravity slightly greater than water). It will be understood by one skilled in the art that there are other methods of purification which could also be practiced with respect to the allyl oil as distilled from the reaction chamber and that all such modifications are also contemplated within the scope of the present invention.

Having obtained a quantity of pure allyl oil, some of this oil may be added back into a prepared mustard product to enhance both the flavor and shelf life of the product. As a whole, this process presents a simple, streamlined method for producing pure allyl oil for use in other industries or products.

Production of Mustard Protein:

It is also contemplated that a similar process to that outlined above could be used to produce a mustard protein fraction from spoiled mustard seed, or mustard seed that is otherwise not of sufficient quality for use in higher level flavoring products. Mustard protein can be used as a binder in meat and fish processing. As mustard protein is major component of mustard seed and mustard cake, 43% by weight after expelling the oil as reported in Canadian Patent No. 2,250,620, the mustard product resultant from the hydrolysis and distillation processes described above presents a significant source of mustard protein.

A problem in the processing of mustard protein present in prior art methods is the presence of residual allyl oil and enzymes, which reduce the shelf life of the mustard protein derived therefrom. Thus, it is desirable to destroy the enzymes and remove the allyl oil in order to use the mustard protein.

It is contemplated that the removal of allyl oil from the mustard stock, in advance of extracting the mustard protein, would be accomplished by way of distillation at a controlled temperature and reduced pressure. Where the mustard stock contained greater than 0.4% allyl oil by weight, a scraping-type heat exchanger apparatus would be used for the hydrolysis and distillation steps. Where the mustard stock contained less than 0.4% allyl oil by weight, a Sun-Kneder apparatus could be used. As described above, the hydrolysis and distillation steps yield a mustard product that is free of, enzyme activity and allyl oil, and which is disinfected. It will be understood that other types of apparatus or methods for extraction of the allyl oil from the remainder of the mustard material could also be contemplated and any such changes and/or attendant process modification s as would be understood by one skilled in the art are contemplated within the scope of the present invention.

The resulting mustard product would then be rehydrated by the addition of water, preferably 10% by weight, and either bittern or caustic soda, preferably 0.02 to 0.1% by weight, after which the product would be compressed to expel liquid, which comprises a mildly denatured crude protein solution. The crude protein solution could then be extracted or processed by any number of standard procedures including but not limited to centrifugation, concentration, fractionation or lyophilization, to yield a spicy mustard protein, which could be used for various purposes.

Production of Dietary Fiber from Mustard Stock:

Once the allyl oil and protein have been extracted from the product using the processes described above, the remainder contains a significant amount of material in the form of dietary fiber. There exists along with the fiber adhering protein solution. The remaining protein solution could be removed from the fiber material by a number of methods including, but not limited to, compressing the insoluble material further to extrude any adhering solution, or centrifugation to separate the protein solution and fiber components. Once the remaining protein was removed, the fiber material could then be dehydrated by normal methods, and upon drying would yield a dietary fiber product for use in the health food, feed and fertilizer industries, among others.

In summary, it can be seen that the invention accomplishes all of its stated objectives. The foregoing is considered as illustrative only of the principles of the invention. Furthermore, since numerous changes and modifications will readily occur to those skilled in the art, it is not desired to limit the invention to the exact construction and operation shown and described. Accordingly, all such suitable change or modifications in structure of operation that may be resorted to are intended to fall within the scope of the claimed invention.

1. A method of fractionating mustard seed, said method comprising the steps of:
a. Cracking mustard seed stock to be processed, wherein said mustard seed stock contains the glucosinolate sinigrin and the enzyme myrosinase;
b. Combining said cracked mustard seed stock with water to activate said enzyme myrosinase, creating an activated mustard slurry;
c. Allowing myrosinase hydrolysis to take place in said activated mustard slurry, wherein said hydrolysis converts said sinigrin into the fraction allyl isothiocyanate (allyl oil) and wherein said hydrolysis is conducted for a period of time being a contact period at a predetermined effective temperature and at a predetermined effective atmospheric pressure; and
d. Separating said allyl oil from the remainder of said activated mustard slurry, wherein the remainder following removal of said allyl oil is now spent mustard slurry.

2. The method of claim 1 wherein said cracked mustard seed stock is cracked by one of the techniques of: crushing, grinding.

3. The method of claim 1 wherein the ratio of cracked mustard seed stock and water in said activated mustard slurry is between 1:1 and 1:7 by weight.

4. The method of claim 1 wherein said predetermined effective temperature is between 40 to 50 degrees Celsius.

5. The method of claim 1 wherein said predetermined effective atmospheric pressure is approximately 45 mM Hg.

6. The method of claim 4 wherein said predetermined effective atmospheric pressure is approximately 45 mM Hg.

7. The method of claim 1 wherein said contact period is long enough to allow for the conversion of substantially all of the sinigrin present in said activated mustard slurry to allyl oil.

8. The method of claim 1 wherein said contact period is between 30 to 90 minutes.

9. The method of claim 1 wherein said allyl oil is separated from the remainder of said activated mustard slurry substantially free of any other components of said activated mustard slurry.

10. The method of claim 1 wherein said allyl oil is separated from the remainder of said activated mustard slurry by distillation.

11. The method of claim 10 further comprising the purification of said separated allyl oil by re-distillation or sedimentation.

12. The method of claim 1 further comprising incubation of the spent mustard slurry for an effective incubation period, to eliminate further myrosinase activity and yield disinfected mustard slurry.

13. The method of claim 12 wherein said incubation takes place at a temperature between 75 and 95 degrees Celsius.

14. The method of claim 12 wherein said incubation period is long enough to deactivate any remaining myrosinase or other enzyme activity in said spent slurry.

15. The product, disinfected mustard slurry, of the process of claim 12.

16. The method of claim 12 further comprising dewatering said disinfected mustard slurry.

17. The product, dewatered mustard slurry, of the process of claim 16.

18. The method of claim 1 wherein said cracked mustard seed stock is mustard cake produced previously by the crushing of mustard seed.

19. The product, allyl isothiocyanate (allyl oil), of the process of claim 1.

20. The product, allyl isothiocyanate (allyl oil), of the process of claim 10.

21. A method of production of allyl isothiocyanate (allyl oil) from mustard seed, said method comprising the steps of:
a. Cracking mustard seed stock to be processed, wherein said mustard seed stock contains the glucosinolate sinigrin and the enzyme myrosinase;
b. Combining said cracked mustard seed stock and water to activate said enzyme myrosinase, creating an activated mustard slurry;
c. Allowing myrosinase hydrolysis to take place in said activated mustard slurry, wherein said hydrolysis converts said sinigrin into allyl isothiocyanate (allyl oil) and where in the hydrolysis is conducted for a period of time, being a contact period of a predetermined effective temperature at a predetermined effective atmospheric pressure; and
d. Extracting said allyl oil from the remainder of said activated mustard slurry.

22. The method of claim 21 wherein said allyl isothiocyanate is separated from the remainder of said activated mustard slurry by distillation.

23. A method of fractionating mustard seed, said method comprising the steps of:
a. Cracking mustard seed stock to be processed, wherein said mustard seed stock contains the glucosinolate sinalbin and the enzyme myrosinase;
b. Combining said cracked mustard seed stock with water to activate said enzyme myrosinase, creating an activated mustard slurry; and
c. Allowing myrosinase hydrolysis to take place in said activated mustard slurry, wherein said hydrolysis converts said sinalbin into the fraction p-hydroxybenzyl-isothiocyanate (benzyl oil) and wherein said hydrolysis is conducted for a period of time being a contact period at a predetermined effective temperature.

24. The method of claim 23 wherein said cracked mustard seed stock is cracked by one of the techniques of: crushing, grinding.

25. The method of claim 23 wherein the ratio of cracked mustard seed stock and water in said activated mustard slurry is between 1:1 and 1:7 by weight.

26. The method of claim 23 wherein said predetermined effective temperature is between 40 to 50 degrees Celsius.

27. The method of claim 23 wherein said contact period is long enough to allow for the conversion of substantially all of the sinalbin present in said activated mustard slurry to benzyl oil.

28. The method of claim 23 wherein said benzyl oil is separated from the remainder of said activated mustard slurry substantially free of any other components of said activated mustard slurry.

29. The method of claim 23 further comprising incubation of the spent mustard slurry for an effective incubation period, to eliminate further myrosinase activity and yield disinfected mustard slurry.

30. The method of claim 29 wherein said incubation takes place at a temperature between 75 and 95 degrees Celsius.

31. The method of claim 29 wherein said incubation period is long enough to deactivate any remaining myrosinase or other enzyme activity in said slurry.

32. The product, disinfected mustard slurry, of the process of claim 29.

33. The method of claim 29 further comprising dewatering said disinfected mustard slurry.

34. The product, dewatered mustard slurry, of the process of claim 33.

35. The method of claim 23 wherein said cracked mustard seed stock is mustard cake produced previously by the crushing of mustard seed

36. The product, p-hydroxybenzyl-isothiocyanate (benzyl oil), of the process of claim 23.

37. The product, p-hydroxybenzyl-isothiocyanate (benzyl oil), manufactured in accordance with the process of claim 23.

38. The method of claim 33 further comprising
a. Rehydrating said disinfected mustard slurry if necessary;
b. Adding a denaturing agent to said disinfected mustard slurry, to yield a denatured mustard protein solution; and
c. De-watering said denatured mustard protein solution to yield the fraction mustard protein.

39. The method of claim 33 wherein said rehydration comprises the addition of water to said disinfected mustard slurry.

40. The method of claim 39 wherein water is added in the range of 10% by weight.

41. The method of claim 38 wherein said denaturing agent is bittern.

42. The method of claim 38 wherein said denaturing agent is caustic soda.

43. The method of claim 38 wherein the amount of denaturing agent added is in the range of 0.02 to 0.1% by weight.

44. The method of claim 40 further comprising purification of said denatured mustard protein solution.

45. The method of claim 44 wherein said purification is carried out using techniques from the group: centrifugation, concentration, fractionation, or lyophilization.

46. The method of claim 38 further comprising dehydrating said mustard protein solution to yield dry dietary fiber derived from mustard seed.

47. The product, mustard protein, of the process of claim 38.

48. The product, dry dietary fiber derived from mustard seed, of the process of claim 38.
